(19) United States
(12) Patent Application Publication
(10) Pub. No.: US 2026/0369066 A1
(43) Pub. Date: Nov. 19, 2026

(54) INFORMATION PROCESSING SYSTEM AND INFORMATION PROCESSING METHOD

(71) Applicant: CANON KABUSHIKI KAISHA, Tokyo (JP)

(72) Inventors: TOMA TANAKA, Kanagawa (JP); RISA NAKAJIMA, Kanagawa (JP); HARUKI IWAI, Tochigi (JP)

(21) Appl. No.: 19/677,207

(22) Filed: May 14, 2026

(30) Foreign Application Priority Data
May 16, 2025 (JP) 2025-082622

(51) Int. Cl. G06V 20/52; G06V 40/16; H04N 7/18

(52) U.S. Cl. CPC G06V 20/52; G06V 40/161; H04N 7/181; G06V 2201/02; G06V 2201/03; G06V 2201/07

(57) ABSTRACT

An information processing system includes: a memory storing instructions, and at least one processor configured to execute the instructions to: acquire a plurality of images photographed by a plurality of cameras installed such that at least part of a medical imaging apparatus is included in a photographing range; detect a plurality of targets from the plurality of images; and select a first image from the plurality of images based on results of the detection of the plurality of targets.

### BACKGROUND

### Field of the Technology

The present disclosure relates to an information processing system and an information processing method.

### Description of the Related Art

In medical fields, large-sized medical imaging apparatuses that capture diagnosis images while controlling postures of beds on which subjects are placed are used. Examples of the medical imaging apparatuses include an X-ray diagnostic apparatus, an X-ray Computed Tomography (CT) apparatus, a Magnetic Resonance Imaging (MRI) apparatus, a Positron Emission Tomography (PET) apparatus, and a Single Photon Emission Computed Tomography (SPECT) apparatus. This type of a large-sized medical imaging apparatus includes multiple movable portions. Therefore, while the medical imaging apparatus is operated, sufficient check safety needs to be performed such that a subject and objects (such as doctors, nurses, and examination equipment) do not contact the movable portions of the medical imaging apparatus.

As one of methods for assisting safety check during examination, there is known a system that photographs a subject and surroundings thereof using cameras installed in an examination room, and

outputs information detected from camera videos and images to a monitor placed near an operator of the medical imaging apparatus. Japanese Patent Laid-Open No. 2014-023592 discloses an X-ray diagnostic apparatus that has a function of switching a display of a monitor from an X-ray image to a camera video when an angle of a bed is a threshold or more and a subject cannot be directly visually checked by an operator of the apparatus.

According to a configuration of performing monitoring using a single camera as in a system of Japanese Patent Laid-Open No. 2014-023592, when the subject moves or positions of the movable portions of the apparatus change, blind spots of the camera are produced, and safety check may not be sufficiently performed using camera videos. Hence, the inventors of the present disclosure have been studying to eliminate blind spots of a plurality of cameras by performing photographing using the cameras, and implement a system having higher safety.

However, if the number of cameras is increased, an operator of a medical imaging apparatus needs to check a plurality of camera images, which causes a new problem that the burden on the operator increases.

### SUMMARY

One aspect of the present disclosure includes an information processing system including: a memory storing instructions, and at least one processor configured to execute the instructions to: acquire a plurality of images photographed by a plurality of cameras installed such that at least part of a medical imaging apparatus is included in a photographing range; detect a plurality of targets from the plurality of images; and select a first image from the plurality of images based on results of the detection of the plurality of targets.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a medical work assist system.

FIG. 2 is a diagram illustrating a configuration example of an image processing apparatus.

FIG. 3 is a flowchart for explaining an operation flow of the medical work assist system.

FIG. 4 is a flowchart for explaining an operation flow of the image processing apparatus.

FIG. 5 is a diagram illustrating an example of sides of a placement region.

FIGS. 6A to 6C are diagrams illustrating examples of a plurality of camera images.

FIGS. 7A and 7B are diagrams illustrating an example of a method for providing a notification of an abnormality-determination result.

FIG. 8 is a diagram illustrating a configuration example of the image processing apparatus according to a second embodiment.

FIG. 9 is a flowchart for explaining an operation flow of the image processing apparatus according to the second embodiment.

### DESCRIPTION OF THE EMBODIMENTS

Hereinafter, embodiments of the present disclosure will be described with reference to the drawings. In this regard, the present disclosure is not limited to the following embodiments. Note that, in the accompanying drawings, the same reference numerals will be assigned to the same or similar components, and redundant description will be omitted or simplified. Hereinafter, when an operator such as a doctor or an engineer uses a medical imaging apparatus, a system to be described as an information processing system can be also used as a medical work assist system that assists work of the operator.

### First Embodiment

The first embodiment of the information processing system (hereinafter referred to as a “medical work assist system”) will be described. Here, an example of a case where the medical imaging apparatus is an X-ray diagnostic apparatus will be described.

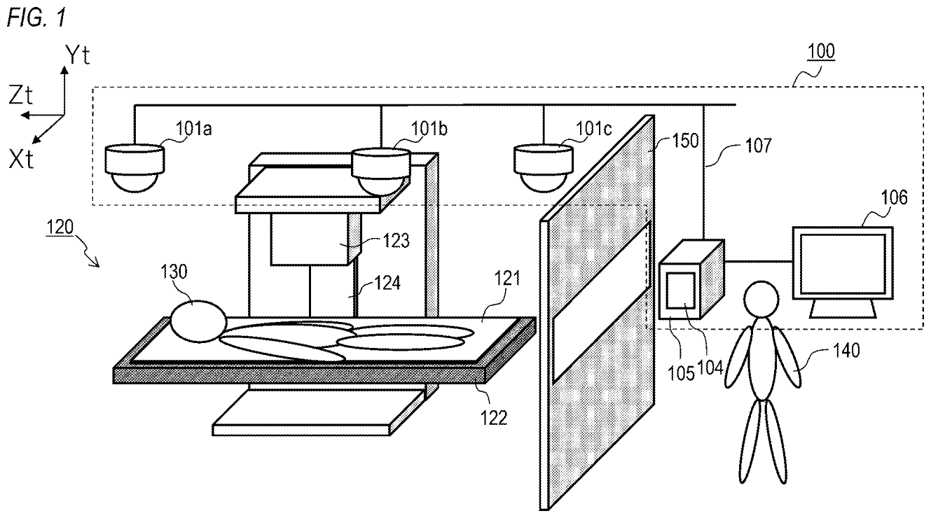

FIG. 1 is a schematic diagram illustrating an example of a configuration of the medical work assist system according to the first embodiment. A medical work assist system 100 is a system for assisting safety check of an X-ray diagnostic apparatus 120, and includes a plurality of cameras 101a to 101c, an image processing apparatus 104 included in a Personal Computer (PC) 105, and a notification apparatus 106. The present embodiment describes an example of a case of three cameras, and the three cameras are the first camera 101a, the second camera 101b, and the third camera 101c. Hereinafter, in a case where common explanation of all the cameras will be given, the cameras will be referred to as a “camera 101”.

The first camera 101a, the second camera 101b, and the third camera 101c are each installed so as to include at least part of the X-ray diagnostic apparatus 120 in the photographing range. The X-ray diagnostic apparatus 120 includes a placement region for placing a subject 130. The placement region described here is a region corresponding to a range in which the subject 130 during examination needs to be accommodated, and is typically a region of a top panel 121 or a bed 122. In other words, if the subject 130 goes out of the placement region during the examination, failures may occur during an operation of the X-ray diagnostic apparatus 120 and the examination, or there may be a risk that the subject 130 contacts movable portions of the X-ray diagnostic apparatus 120. The first camera 101a, the second camera 101b, and the third camera 101c are, for example, optical cameras. Although visible light cameras are used in the present embodiment, infrared cameras, rangefinder cameras, or the like may be used. In the present embodiment, the plurality of cameras 101a to 101c are installed such that the subject 130 can be photographed by any one of the cameras at all times even when the bed 122 and the top panel 121 of the X-ray diagnostic apparatus 120 move. Note that, although the three cameras 101a to 101c are installed in the present embodiment, any number of cameras may be installed as long as the number of cameras is two or more. After the medical work assist system 100 is activated, the first camera 101a, the second camera 101b, the third camera 101c, the image processing apparatus 104, and the PC 105 can communicate with each other via a network 107.

In the X-ray diagnostic apparatus 120, an operator 140 of the X-ray diagnostic apparatus 120 is concerned to be exposed to exposure at a time of photographing a radiological image of the subject 130, and often performs diagnosis through a protection wall 150 with a lead glass while protecting the operator 140. The notification apparatus 106 is near the operator 140 to provide information used for diagnosis to the operator 140. According to the present embodiment, the notification apparatus 106 is a monitor (a display portion or a display), and presents information used for diagnosis such as the photographed radiological image, a camera image, and subject information. The notification apparatus 106 may provide a notification to the operator 140 by a voice using a speaker or the like instead of the monitor according to the information to be provided to the operator 140.

The X-ray diagnostic apparatus 120 including the placement region will be described. The X-ray diagnostic apparatus 120 includes the top panel 121, the bed 122, an X-ray tube 123, and a support column 124 as main components. Note that, in FIG. 1, a lateral direction of the top panel 121 is defined as an Xt direction, a direction perpendicular to a plane of the top panel 121 on which the subject 130 is placed is defined as a Yt direction, and a longitudinal direction of the top panel 121 is defined as a Zt direction.

During major examination such as upper gastrointestinal examination, the subject 130 lies on the top panel 121 along the longitudinal direction (Zt direction) of the top panel 121. The top panel 121 moves on the bed 122 along the Xt direction, and the X-ray tube 123 and the support column 124 move along the Yt direction and the Zt direction. The top panel 121, the bed 122, the X-ray tube 123, and the support column 124 can integrally rotate about an axis along the Xt direction, and change a posture of the subject 130 from a lying state (lying position) to a standing state (standing position). That is, the placement region for placing the subject 130 is movable. Since the X-ray diagnostic apparatus 120 includes multiple movable portions, the operator 140 who operates the X-ray diagnostic apparatus 120 needs to predict a behavior of the subject 130 while observing the state of the subject 130 to ensure safety.

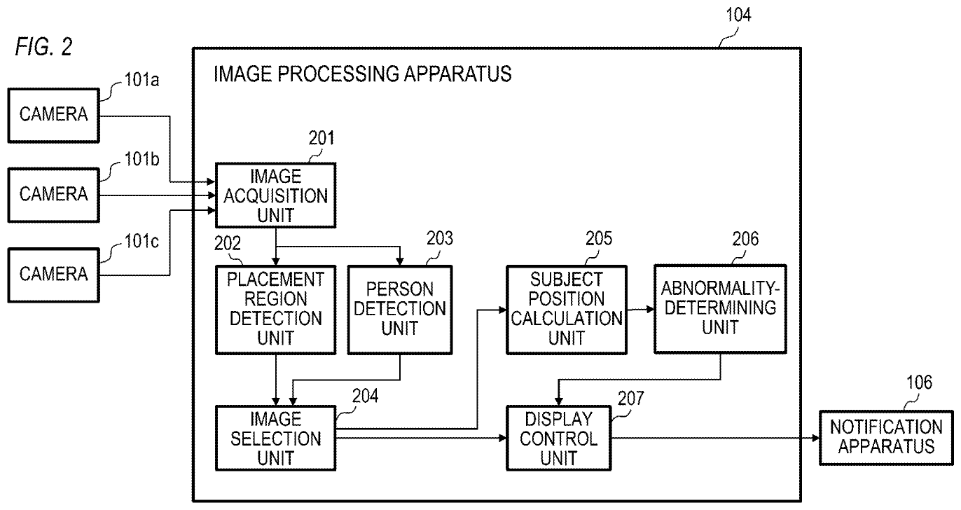

FIG. 2 is a schematic diagram illustrating an example of a configuration of the image processing apparatus 104.

The image processing apparatus 104 includes an image acquisition unit 201, a placement region detection unit 202 and a person detection unit 203 that are detection units, an image selection unit 204, a subject position calculation unit 205, an abnormality-determining unit 206, and a display control unit 207.

The image acquisition unit 201 acquires image data from each of the plurality of cameras 101a to 101c. This image data is obtained by photographing the subject 130 in a state where the subject 130 is placed on the bed 122. The placement region detection unit 202 detects a placement region (first target) for placing the subject 130 from the image data acquired by the image acquisition unit 201. The person detection unit 203 detects a person (second target) from the image data acquired by the image acquisition unit 201. The person detection unit 203 may be configured to detect the whole body of a person, may be configured to detect only specific parts of the person (such as the head, the both hands, and the both feet), or may be configured to detect both the whole body and specific parts. Although a person who is a detection target is mainly the subject 130 on the placement region, a doctor, a nurse, or an engineer present near the X-ray diagnostic apparatus 120 may be a detection target. The placement region detection unit 202 and the person detection unit 203 execute detection processing for each of the plurality of images obtained from the plurality of cameras 101a to 101c. The image selection unit 204 selects an image (first image) to be used for safety check from the plurality of these images based on detection results of the plurality of images obtained by the placement region detection unit 202 and the person detection unit 203. The image selection unit 204 selects an abnormality-determining image to be provided for the abnormality-determining unit 206 to perform processing of deciding an abnormality of the subject 130, and selects a display image to be provided for the operator 140 to perform observation. The abnormality-determining image and the display image may be the same images or may be different images. Note that, although both of the abnormality-determining image and the display image are selected in the present embodiment, only the abnormality-determining image may be selected only for the purpose of abnormality determination, and only the display image may be selected only for the purpose of observation of the camera images. The subject position calculation unit 205 calculates the position of the subject 130 from the image data selected by the image selection unit 204. The abnormality-determining unit 206 determines an abnormality in the position of the subject 130 based on the placement region detected by the placement region detection unit 202 and position data of the subject calculated by the subject position calculation unit 205. The display control unit 207 controls an output to the notification apparatus 106 (display unit) observed by the operator 140 based on the first image selected by the image selection unit 204 and an abnormality-determination result of the abnormality-determining unit 206.

The PC 105 including the image processing apparatus 104 includes a Central Processing Unit (CPU). The CPU performs a predetermined operation according to a program recorded in a Random Access Memory (RAM), a Read Only Memory (ROM), a Hard Disk Drive (HDD), or the like included in another apparatus that functions via the PC 105 or the network 107. Processing performed by the CPU include each processing performed by the image acquisition unit 201, the placement region detection unit 202, the person detection unit 203, the image selection unit 204, the subject position calculation unit 205, and the abnormality-determining unit 206 in addition to control of each function included in the PC 105. Note that each of the above processing may be also executed by a Micro Processing Unit (MPU) or a microcomputer instead of the CPU. Furthermore, in addition to main processors such as a CPU and an MPU, an auxiliary processor such as a Graphics Processing Unit (GPU) may be included.

Here, although the example where the image processing apparatus 104 is included in the PC 105 has been described, the image processing apparatus 104 can be configured as a workstation, a server, a Field Programmable Gate Array (FPGA), an Application Specific Integrated Circuit (ASIC), a microcomputer, or the like. Furthermore, the image processing apparatus 104 can be also configured as a tablet PC, a smartphone, or the like integrated with the notification apparatus 106. Furthermore, all or part of the functions of the image processing apparatus 104 may be implemented by cloud computing or distributed computing.

A flow of processing performed the medical work assist system 100 will be described.

The first camera 101a, the second camera 101b, and the third camera 101c transmit camera image data acquired by photographing the placement region and the subject 130 at an angle of view including the placement region and the subject 130, to the image processing apparatus 104 built in the PC 105 per frame. The image processing apparatus 104 detects from the transmitted camera image data, for example, the top panel 121 that is the placement region and the subject 130 that is present in the placement region. Furthermore, the image processing apparatus 104 selects an abnormality-determining image provided for subject position calculation and abnormality determination and a display image provided for a display of the notification apparatus 106 from the plurality of camera images acquired by the cameras 101a to 101c based on these detection results. The image processing apparatus 104 generates display image data obtained by cropping and synthesizing each of the selected camera images, and display image data indicating a probability of an interference between the subject 130 and the X-ray diagnostic apparatus 120. The display image data is displayed on the notification apparatus 106 per frame via the PC 105 as needed.

The operator 140 of the X-ray diagnostic apparatus 120 looks at a display screen that is the display unit included in the notification apparatus 106, and operates the X-ray diagnostic apparatus 120 while checking safety of the subject 130.

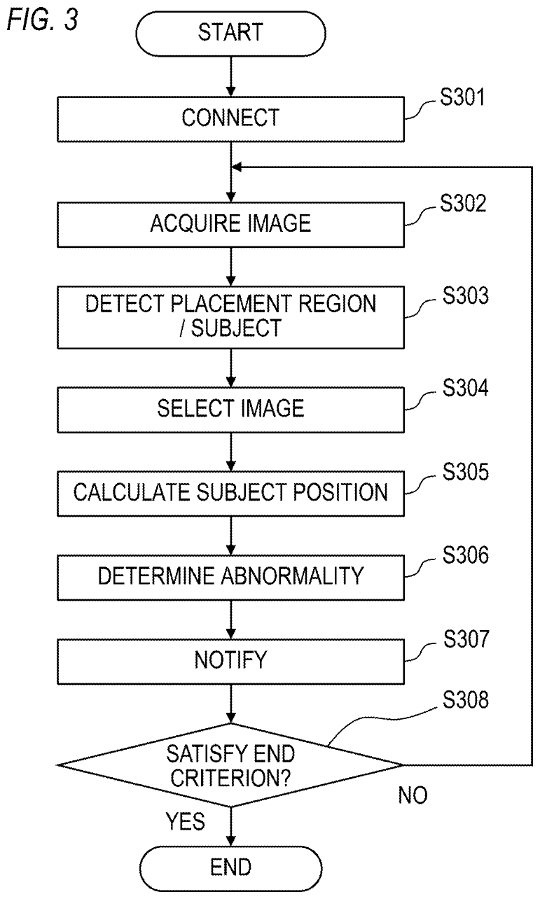

A detailed processing procedure performed by the medical work assist system 100 will be described with reference to FIG. 3. FIG. 3 is a flowchart illustrating an example of a processing procedure of a work assist method according to the present embodiment.

The work assist method according to the present embodiment includes connection process S301, image acquisition process S302, placement region/subject detection process S303, image selection process S304, subject position calculation process S305, abnormality determination process S306, and notification process S307. These processing is implemented by a CPU (processor) of the image processing apparatus 104 by executing a program.

Connection process S301 is a process in which the image processing apparatus 104 opens an input stream of camera image data sent from the first camera 101a, the second camera 101b, and the third camera 101c, and an output stream for transmitting the display image data to the PC 105.

Image acquisition process S302 is a process in which the image acquisition unit 201 acquires the latest camera image data sent from the input stream.

Placement region/subject detection process S303 is a process in which the placement region detection unit 202 detects the placement region for placing the subject 130 from each camera image data acquired by the image acquisition unit 201. Furthermore, in process S303, the person detection unit 203 detects the subject 130. That is, the medical work assist system 100 according to the present embodiment detects two detection targets of the placement region and the subject 130 from each camera image data. The placement region can be detected by the placement region detection unit 202 by, for example, specifying from the image data a plurality of feature points located at a boundary of the placement region. An example of a feature point estimation method includes a method for estimating an existence probability of feature points in the placement region using a machine learning model. In addition, a method for detecting a pixel region corresponding to the placement region in the camera image data by a Deep Neural Network (hereinafter referred to as a DNN) may be used. In this case, a binary image (hereinafter referred to as a “placement region mask”) whose values of pixels determined to correspond to the placement region are 1 and whose other values of pixels are 0 is output as a detection result. A machine learning model such as the DNN can be also used for detection of the subject 130. In a case where a plurality of persons are detected from the camera image data, a person present in the placement region may be determined as the subject 130. Note that, although the two targets of the placement region and the subject 130 are detected for the purpose of observing the subject 130 in the present embodiment, a detection target can be also changed as appropriate according to a purpose or a target for observation (monitoring). For example, the placement region and other parts of the medical imaging apparatus, persons such as a subject and doctors, objects such as desks and chairs, medical tools such as catheters and syringes, or the like may be selected as detection targets. In addition, face recognition information of the subject 130, vital information of the subject, or the like may be selected as a detection target. As described above, by combining at least two or more detection targets, it is possible to flexibly change an image selection criterion for an operator's observation in image selection process S304 to be described later. Furthermore, it is also possible to improve reliability of image selection process S304 and abnormality determination process S306.

Image selection process S304 is a process in which the image selection unit 204 selects an image based on the placement region of each camera image data and the detection result of the subject 130 detected in placement region/subject detection process S303. Details of processing will be described later. In the present embodiment, in image selection process S304, selection of the abnormality-determining image used for abnormality determination processing described later, and selection of the display image used for providing a notification to the operator 140 are performed. The abnormality-determining image and the display image may be the same camera image or may be different camera images.

Subject position calculation process S305 is a process in which the subject position calculation unit 205 calculates a position of the subject 130 on the placement region. Data of the position of the subject 130 is, for example, coordinate data of an anatomical part (landmark) of the subject 130. The landmark may be the entire body of the subject 130, or may be extracted as a position of a portion of the body of the subject 130. Landmarks such as the head portions and the face portions can be exemplified as the eyes, the nose, the both ends of the mouth, the chin, the ears, the parietal, and the like, landmarks of the body portions can be exemplified as the base of the neck, the shoulders, the center of the chest, the waist, the spine, and the like, and landmarks of the arms and the legs can be exemplified as the elbows, the wrists, the hands, the fingertips, the knees, the toes, and the like. These landmarks are also referred to as feature points. Subject position data may be extracted as detailed posture information of the subject 130 generated by specifying the respective landmarks of the subject 130 and combining the respective landmarks. A method for calculating a subject position includes a method that uses a machine learning model. More specifically, a trained DNN can be used as the machine learning model. As the trained DNN, a model that outputs positions of parts (such as the arms and the legs) of the subject 130 of interest as information on a bounding box or a binary mask, and a model that outputs a plurality of landmarks and posture information of the subject 130 can be used. Note that a relative position of the subject with respect to the placement region may be calculated based on the placement region detected in placement region/subject detection process S303. At this time, it is possible to reduce a processing load of subject position calculation by appropriating a detection result of placement region/subject detection process S303 that is common processing.

Abnormality determination process S306 is a process in which the abnormality-determining unit 206 determines an abnormality of the subject 130 using the abnormality-determining image selected in image selection process S304. In the present embodiment, the abnormality-determining unit 206 determined whether or not there is a predetermined part of the body of the subject 130 in the placement region, based on the placement region detected from the abnormality-determining image and the position data of the subject 130. When there is no predetermined part in the placement region, that is, when there is a predetermined portion outside the placement region, the abnormality-determining unit 206 outputs a determination result indicating that there is an abnormality. Furthermore, when a predetermined part is present in the placement region, that is, when there is no predetermined part outside the placement region, the abnormality-determining unit 206 outputs a determination result indicating that there is no abnormality. That is, when the subject 130 is out of the placement region, it is assumed that there is a risk of an interfere (contact) with the X-ray diagnostic apparatus 120, and it is determined that there is an abnormality. Note that, as for coordinates of the placement region and coordinates of the predetermined part of the subject 130 in the abnormality-determining image, data calculated in placement region/subject detection process S303 and subject position calculation process S305 may be appropriated, or may be calculated in more detail in abnormality determination process S306. Any algorithm may be used for an abnormality determination algorithm. For example, an abnormality may be determined based on an overlap of binary masks of the placement region and the specific part of the subject 130, or a boundary line obtained by connecting feature point coordinates of the placement region and the specific part coordinates of the subject 130.

Note that, although the probability of the interference between the subject 130 and the X-ray diagnostic apparatus 120 is determined in the present embodiment, abnormal states other than the probability of the interference may be determined as long as the abnormal states can be determined based on camera image data. For example, the abnormality-determining unit 206 may determine an abnormality in the physical condition of the subject 130 based on a feature amount extracted from the abnormality-determining image. As one example of this determination, the abnormality-determining unit 206 can detect the face portion of the subject 130 from the abnormality-determining image, and determine the abnormality in the physical condition of the subject 130 based on color information of this face portion. More specifically, the abnormality-determining unit 206 may compare the color information (i.e., complexion) of the face portion of the subject 130 between a time point before a start of examination and a present time point, and determine that there is an abnormality in the physical condition of the subject 130 when deciding that the complexion has changed from a predetermined criterion. In another example, the abnormality-determining unit 206 can also detect the face portion of the subject 130 from the abnormality-determining image, and determine the abnormality in the physical condition based on motions of facial parts (such as the eyes and the mouth) and a facial expression of the subject 130. Additionally, the abnormality-determining unit 206 may determine an abnormality in an anesthetic state of the subject 130 based on the feature amount extracted from the abnormality-determining image. For example, the abnormality-determining unit 206 may detect specific parts (such as the head, the hands, or the feet) of the subject 130 from the abnormality-determining image, and determine that the anesthesia has been worn off when motion quantities of the specific parts are greater than the predetermined criterion. Additionally, the abnormality-determining unit 206 may determine a mix-up of the subject 130 based on the feature amount extracted from the abnormality-determining image. For example, the abnormality-determining unit 206 may check an identity by face recognition, or recognize an identification tag attached to the wrist or clothes and check the identity. The above-described abnormality determination may be performed instead of determination on the interference probability in the present embodiment, or a plurality of types of abnormality determination may be performed. The items of abnormality determination to be executed may be freely combined by a user.

Notification process S307 is a process of notifying the operator 140 of the determination result in abnormality determination process S306. A notification may be provided only when it is determined in abnormality determination process S306 that there is an abnormality, or a notification may be provided regardless of whether or not there is an abnormality. The display control unit 207 generates notification information to be notified to the operator 140 based on the display image selected by the image selection unit 204, the abnormality-determining image used for the abnormality determination by the abnormality-determining unit 206, and a result of the abnormality determination, and outputs the notification information to the notification apparatus 106. In a case where the notification apparatus 106 is the display unit, the display control unit 207 may display the display image as the notification information on the display unit. At this time, the display control unit 207 may output the entire display image, or crop and display part of the display image (a region of interest). Furthermore, the display control unit 207 may output the display image as it is, or process the display image or synthesize the display image with other information to output. The display control unit 207 may output the display image to the notification apparatus 106 regardless of whether or not there is an abnormality, and enable the operator 140 to observe the placement region or the subject 130 at all times. As another method, the display control unit 207 may be triggered by determination that there is an abnormality in a state where the display image is output at all times to switch the display image to the abnormality-determining image, or output both the display image and the abnormality-determining image. Note that, as a method for providing a notification of the abnormality state of the subject 130 on the screen, there is a method for displaying a text for providing a notification of safety/abnormality, or emphasizing and displaying a dangerous part on a pictogram to be overlaid and displayed separately from the camera image. Furthermore, there is a method for emphasizing an abnormality part in a camera image with a bounding box, or cropping the abnormality part and enlarging and displaying the abnormality part. That is, information and images necessary for safety check may be notified to the operator 140 timely by an appropriate method.

In end determination process S308, an end of the operation of the medical work assist system 100 is determined according to the predetermined criterion. In a case where it is determined in end determination process S308 that the end criterion is not satisfied, the flow returns to image acquisition process S302 to perform the processes up to notification process S307 again. In a case where it is determined in end determination process S308 that the end criterion is satisfied, the work assist method according to the present embodiment is ended. A criterion for deciding the end can be determined as appropriate without any particular limitation, and may be, for example, whether or not there is an end instruction from the operator 140. In this case, notification processing may be stopped according to an instruction from the operator 140. Furthermore, for example, the notification processing can be linked with driving of the X-ray diagnostic apparatus 120, and can be also stopped when driving or the power source of the X-ray diagnostic apparatus 120 is turned off.

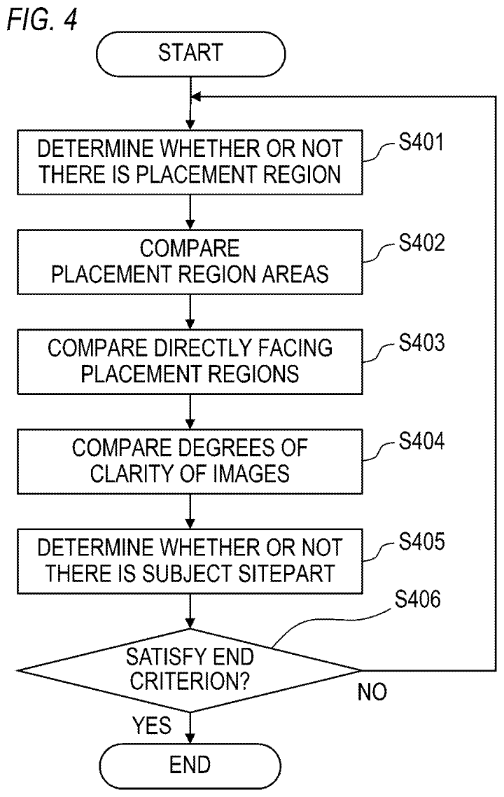

FIG. 4 is a flowchart illustrating an example of a processing procedure of selecting the abnormality-determining image or the display image used for notification to the operator 140 from two or more camera images in image selection process S304. In the present embodiment, by narrowing down the images meeting predetermined selection conditions based on the flowchart in FIG. 4, the abnormality-determining image and the display image to be used for subsequent processing are selected.

In placement region presence/absence determination process S401, the image selection unit 204 selects an image that matches with the selection conditions from a plurality of camera images (three camera images in the present embodiment) under a selection condition “the placement region is detected from the camera images”. At this time, the image selection unit 204 may determine whether or not the placement region has been detected from the camera images, based on the detection result in placement region/subject detection process S303 (FIG. 3). For example, this determination can be made based on whether or not there is a placement region mask. Since the camera image in which the placement region is not reflected does not reflect the subject 130, either, the camera image is not suitable for abnormality determination or notification to the operator 140, and therefore is preferentially excluded. Note that, when there is not even one camera image including the placement region, an error (exception) indicating that there is no image to select is returned to end the processing in FIG. 4.

In placement region area comparison process S402, the image selection unit 204 compares the “sizes of areas of the placement region” in the camera images. More specifically, a selection priority is increased for an image including a larger total number of pixels of the placement region mask. This is because, as the area of the placement region is larger, it can be determined that the placement region (and the subject 130) is more largely reflected. As the subject 130 is more largely reflected in the image, it can be expected that accuracy of abnormality determination improves, and the operator 140 easily visually checks camera images even when the camera images are displayed on the notification apparatus 106, which is useful for safety check. In this process S402, only one camera image in which the area of the placement region is the largest may be selected (in that case, processes S403 to S405 are skipped). Alternatively, one or more camera images in which the area of the placement region is larger than the predetermined criterion (threshold) may be selected to pass to next and subsequent processes.

In placement region direct facing comparison process S403, the image selection unit 204 compares “the littleness degrees of inclinations of the placement region” in the camera images. The inclination of the placement region means that the sides of the placement region in the Xt direction in FIG. 1 in particular incline with respect to an X axis (or a Y axis) of the image data. The little inclination of the placement region indicates that the camera directly faces the placement region, and the great inclination of the placement region indicates that the camera does not directly face the placement region. When the cameras directly face the placement region, an image having little distortion and occlusion can be obtained, so that it can be expected that accuracy of abnormality detection and image recognition improves. In this process S403, only one camera image in which the inclination of the placement region is the least may be selected (in that case, processes S404 and S405 are skipped). Alternatively, one or more camera images in which the inclination of the placement region is less than the predetermined criterion (threshold) may be selected to pass to next and subsequent processes.

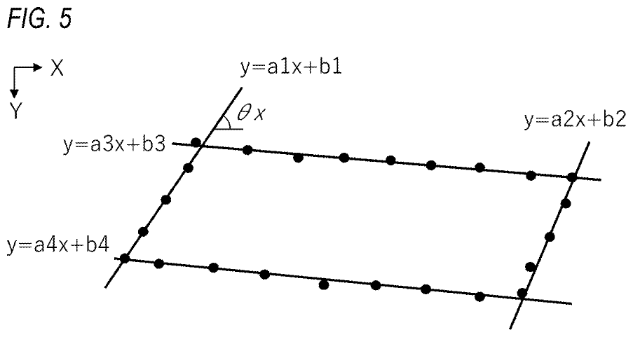

An example of a specific method will be described. First, straight lines are detected based on the coordinates of the detected feature points of the placement region using Hough transform to obtain an intersection of the straight lines. Thus, it is possible to find the sides of the placement region in the image as in FIG. 5. The black circles in FIG. 5 indicate the feature points of the placement region detected from the image, and four straight lines indicate four sides of the placement region found by Hough transform. Since the placement region has a substantially rectangular shape, it is found that the short side is a side near which the head or the feet of the subject 130 is placed. Since the inclination of the short side is particularly important for checking whether or not the cameras and the placement region directly face, determination is made by calculating the inclination with respect to the short side in the present embodiment. When the side on which the head of the subject 130 is placed is y=a1x+b1, an inclination θx of this short side with respect to the X axis is given by the following equation.

θx=arctan (a1) (1)

Furthermore, when an inclination θy with respect to the Y axis needs to be checked, it is possible to calculate the inclination θy by the following equation using θx obtained by equation (1).

θy=90°−θx.

The less inclination among the inclination θx with respect to the X axis and the inclination θy with respect to the Y axis may be used for evaluation of the inclination of the placement region. Which one of the inclination θx and the inclination θy is less may change according to the angle of the bed 122. Furthermore, an image in which the inclination of the short side with respect to the X axis or the Y axis is the least is selected as an image that the most directly faces the cameras.

Note that, as a result of Hough transform, part of the vertex may be located at the edge of the image or outside the screen. For example, the head side of the subject 130 among the sides in the Xt direction in FIG. 1 may be out of the image in the standing position state. To prevent erroneous determination, it is desirable that the angle of each side of the placement region is calculated separately for each of the opposite short sides, or that the angle is calculated by calculating an average of the angles. When the placement region is photographed from an oblique angle, the hands and the feet of the subject 130 are readily hidden, an error readily occurs during subject position calculation of performing estimation from two-dimensional image information, and therefore the directly facing camera image is selected as much as possible.

In image clarity degree comparison process S404, the image selection unit 204 compares “the degrees of clarity of the placement region” in the camera images. More specifically, the image selection unit 204 analyzes and compares the degrees of clarity of images (placement region images) corresponding to placement region mask regions in the camera images. The degree of clarity may be evaluated based on indices such as edge strength of the image, a high frequency component, a contrast, or the like, or may be evaluated by local pattern matching or the like. When resolutions of placement region images are different, an image having a higher resolution may be selected. This is because it can be expected that the camera that captures images with little blur or shake, and clearly captures the placement region and the subject 130 has the enhanced detection accuracy for the placement region and the subject 130.

In subject part presence/absence determination process S405, the image selection unit 204 selects an image under a selection condition “the placement region and the subject 130 or a specific part of the subject 130 have been detected from the image”. The image selection unit 204 may use the detection results of the placement region detection unit 202 and the person detection unit 203 in placement region/subject detection process S303 (FIG. 3), or the image selection unit 204 itself may perform equivalent detection processing.

When, for example, an interference between the X-ray diagnostic apparatus 120 and the subject 130 is determined, whether or not the hands of the subject 130 are reflected is particularly important. Depending on the position calculation processing method of the subject 130, processing may be performed so as to estimate the position of the hidden one hand even when the one hand is not reflected. Since this position calculation processing method leads to erroneous detection or a significant decrease in accuracy, it is preferable in image selection process S304 to exclude an image or lower a priority of the image in which the both hands are not reflected. In the present embodiment, to prevent erroneous selection and improve the accuracy, final image selection is performed based on at least two or more detection results (of the placement region and the subject). For example, some machine learning models may erroneously recognize the back surface of the top panel 121 as the placement region, or may erroneously recognize the subject or a part of the subject when a plurality of persons enter the photographing range.

In end determination process S406, the image selection processing is ended according to the predetermined criterion. A typical example of an end determination criterion is whether or not the number of finally selected images is one. In addition, even when there is no more condition for selecting images, image selection is ended. Furthermore, although end determination is performed after a series of selection is completed in the present embodiment, end determination may be performed every time immediately after each process.

Although images are gradually narrowed down by applying the selection conditions sequentially based on the flowchart in FIG. 4 in the present embodiment, the image selection method is not limited to this. For example, the image may be selected under a single selection condition. Furthermore, the order of the selection conditions (the order of execution of processes S401 to S405) may be rearranged. Furthermore, it is also possible to group a plurality of selection conditions into several groups, execute image selection processing in parallel, and select an image in each group. Furthermore, a score indicating the degree of match with the selection conditions is calculated in each of processes S401 to S405, the score for each selection condition is weighted and added to calculate a total evaluation score, and an image to be finally selected may be determined based on this evaluation score. The number of the final selected images may not be one, and a selection criterion for the abnormality-determining image and a selection criterion for the display image to be notified to the operator 140 may be provided individually.

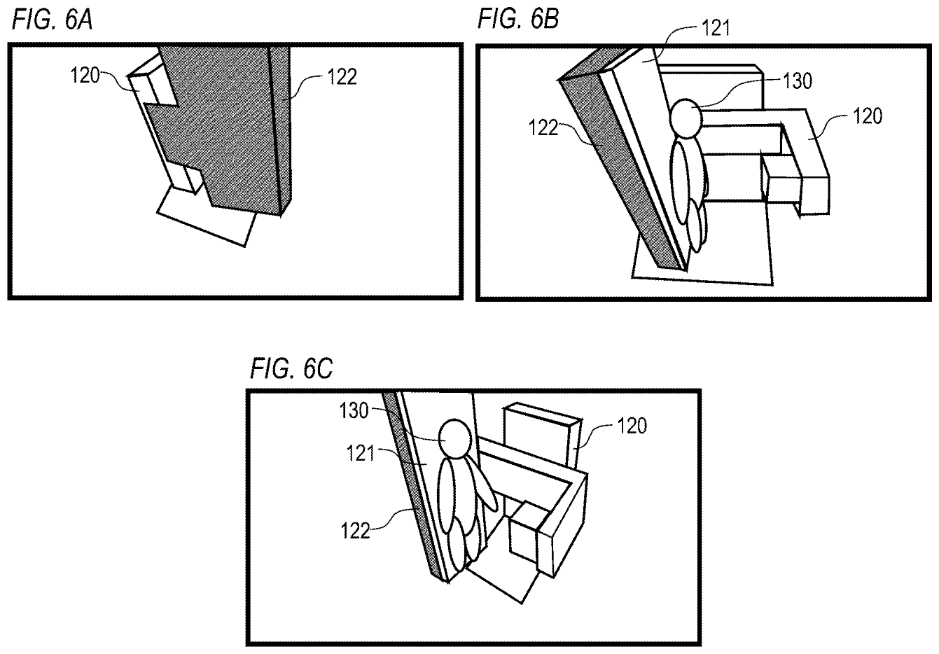

FIGS. 6A to 6C illustrate an example of images obtained by simultaneously photographing the X-ray diagnostic apparatus 120 and the subject 130 in the standing position state by the first camera 101a, the second camera 101b, and the third camera 101c. For the sake of explanation, part of the structure of the X-ray diagnostic apparatus 120 and the like are omitted. FIG. 6A illustrates the image captured by the first camera 101a, FIG. 6B illustrates the image captured by the second camera 101b, and FIG. 6C illustrates the image captured by the third camera 101c. An example of a case where each image is subjected to the image selection processing will be described. First, in placement region presence/absence determination process S401, the detection result of the placement region is checked for each image. Although, when the feature points of the top panel 121 are detected by the placement region detection processing, the top panel 121 portion is reflected in the image in FIG. 6B and the image in FIG. 6C, and consequently the placement region can be correctly detected, the top panel 121 is not reflected in the image in FIG. 6A, and therefore the placement region is not detected. Accordingly, the image in FIG. 6A is determined as an image that is not suitable for abnormality determination or notification, and is excluded. Next, in placement region area comparison process S402, comparison between the image in FIG. 6B and the image in FIG. 6C shows that the placement region in FIG. 6C is slightly wider. Accordingly, it is determined that the image in FIG. 6C is more suitable for the abnormality determination and notification to the operator 140, and the image in FIG. 6C is selected and the processing is ended.

The image selection processing may be executed for each frame (every time images are imported from the cameras 101a to 101c). In this regard, when a camera to be selected is frequently switched, flickering or a feeling of obstruction of the display on the display unit may occur, which may cause a failure of safety check. Accordingly, the image selection processing may be executed at a cycle of a fixed time period (e.g., once every several seconds to several tens of seconds, etc.), and the image selection processing may be executed at, for example, a timing at which movement of the X-ray diagnostic apparatus 120 ends to reduce the frequency to switch between images. The movement stop of the X-ray diagnostic apparatus 120 can be determined when the X-ray diagnostic apparatus 120 and the PC 105 communicate and thereby receive an end of the operation, or when motion quantities of the feature points of the detected placement region are a certain value or less.

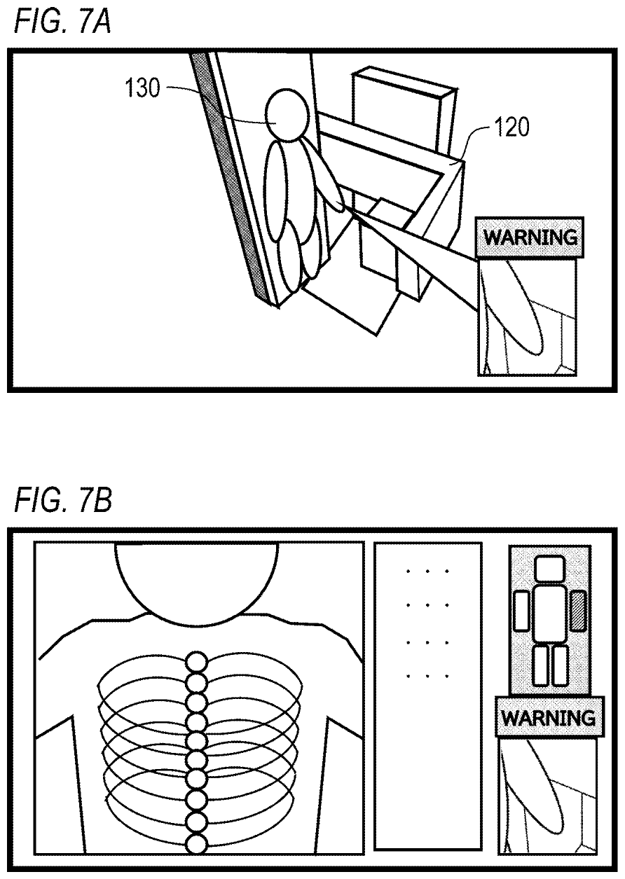

In the image in FIG. 6C, the left hand of the subject 130 is out of the placement region. If part of the body is out of the placement region, the part of the body may interfere with a movable portion of the X-ray diagnostic apparatus 120, which is dangerous. Accordingly, it is determined in subsequent abnormality determination process S306 that there is an abnormality in the image in FIG. 6C. In a case where a determination result indicating that there is the abnormality is obtained, the display control unit 207 may output a display screen for notifying the operator 140 of the abnormality to the notification apparatus 106. In an example of the display screen illustrated in FIG. 7A, notification information (text information “WARNING”) for notifying the operator of the contents of the abnormality is displayed on the display unit together with the abnormality-determining image. Furthermore, an image in which an abnormality part has been emphasized (an image in which a left-hand portion determined as the abnormality part has been enlarged) is displayed together with the entire abnormality-determining image. Such a display screen includes a layout that is excellent in grasping the abnormality part in a short time. FIG. 7B illustrates an example where the abnormality part of the subject 130 is displayed by combining emphasis display and enlargement display by a pictogram while other diagnostic information (such as an X-ray image) is displayed. Furthermore, notification information with a text is also displayed. The display screen in FIG. 7B includes a layout that can notify the operator 140 while making the display of the notification apparatus 106 efficient.

The configurations of the X-ray diagnostic apparatus 120 and the medical work assist system 100 described in the present embodiment are merely examples of implementation of the present disclosure. As long as the configuration of the medical work assist system 100 can automatically select an abnormality-determining image or a display image to be used for safety check from a plurality of camera images, the configuration of the medical work assist system 100 is not limited to the above-described configuration. For example, the camera 101 may be fixed to the X-ray diagnostic apparatus 120 or may be installed on a ceiling, a tripod, or the like. Furthermore, although the present embodiment has described the example of the X-ray diagnostic apparatus as the medical imaging apparatus, any medical imaging apparatus may be used as long as the medical imaging apparatus is a CT, an MRI, or the like in which the apparatus main body and the subject 130 move relatively to each other.

As described above, the medical work assist system 100 according to the present embodiment can select camera images suitable for abnormality determination and display with a low load from a plurality of camera images obtained by photographing the X-ray diagnostic apparatus 120. Thus, the operator 140 can observe the plurality of camera images, and perform diagnosis while observing the subject 130 without increasing work of selecting a desired camera image.

### Second Embodiment

The second embodiment of the medical work assist system will be described.

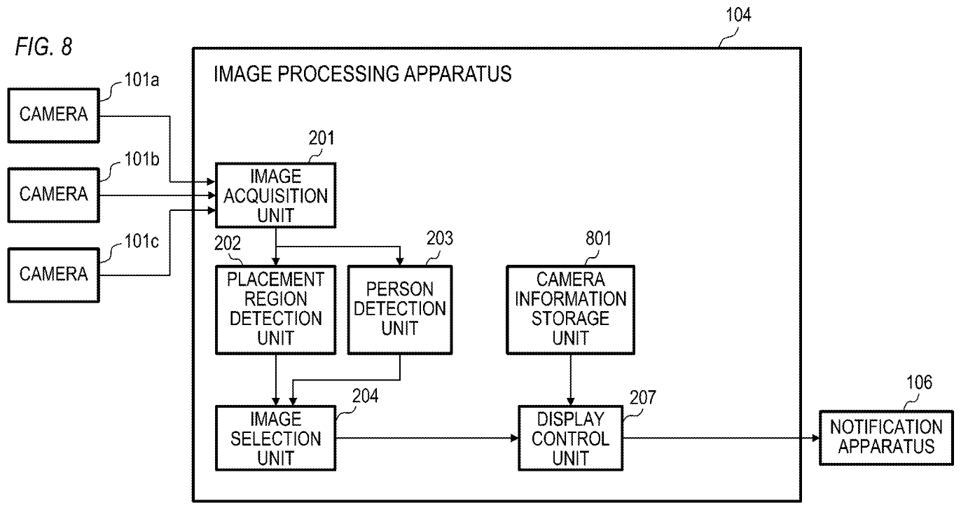

FIG. 8 illustrates the configuration of the image processing apparatus 104 according to the second embodiment. The second embodiment differs from the first embodiment (FIG. 2) in including a camera information storage unit 801. Explanation on the same components as those in the first embodiment will be omitted.

The camera information storage unit 801 stores installation position information of the first camera 101a, the second camera 101b, and the third camera 101c. The installation position information is more specifically information on whether or not the cameras cover a blind spot of an operation room at a time when the X-ray diagnostic apparatus 120 moves. Although the operator 140 inputs the installation position information via the PC 105 in the present embodiment, this information may be acquired by communicating with each camera using the network 107. Alternatively, the installation position information may be calculated by acquiring and processing the relative coordinates of each camera, the X-ray diagnostic apparatus 120, and the operation room.

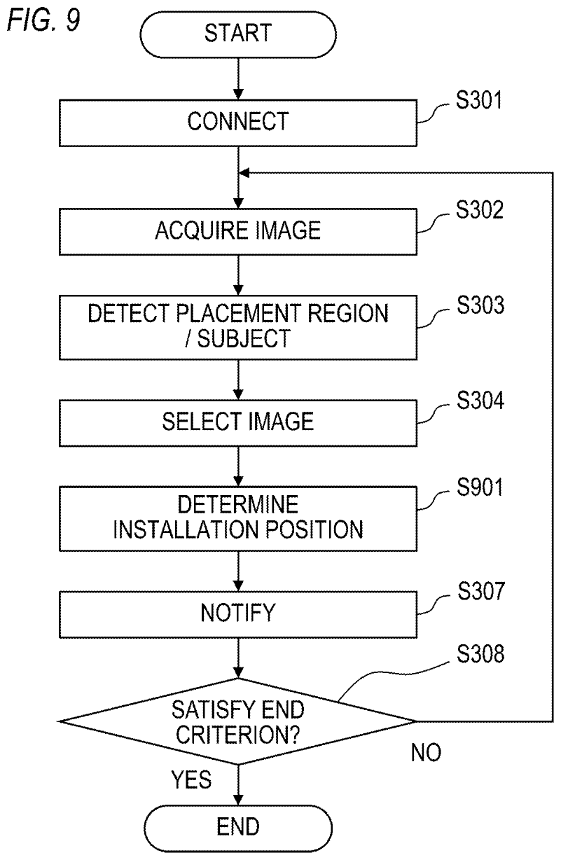

FIG. 9 illustrates a flowchart illustrating an example of an image selection method according to the present embodiment. Explanation on the same processes as those of the flowchart in FIG. 3 described in the first embodiment will be omitted.

In installation position determination process S901, the display control unit 207 acquires from the camera information storage unit 801 the installation position information of the camera associated with the display image selected in image selection process S304. The display control unit 207 determines whether or not the selected display image is an image including in the photographing range a region (i.e., a region that is not seen from the inside of the operation room through a glass window of a protection wall 150) that is at a blind spot from a position at which the operator 140 is present. In a case where an image is determined as the image including in the photographing range the region that is at the blind spot, the display control unit 207 outputs the display image to the notification apparatus 106 in notification process S307. On the other hand, in a case where an image is determined as the image that does not include in the photographing range the region that is at the blind spot, (that is, when the operator 140 can directly visually check the photographing range of the display image), the display control unit 207 does not output the display image to the notification apparatus 106.

The present embodiment targets at a case where the operator 140 diagnoses the subject 130 while performing safety check of the subject 130 without depending on the medical work assist system 100. Only when the X-ray diagnostic apparatus 120 is moved to an angle of view at which the subject 130 is not directly visually checked from the operation room in which the operator 140 is present, the notification apparatus 106 is caused to select and display a camera image in which the placement region (and the subject 130) could have been detected. Thus, a target camera image is displayed on the notification apparatus 106 only when the placement region can be detected from the target camera image, so that it is possible to make the display of the notification apparatus 106 efficient while selecting a camera having a necessary angle of view from the plurality of cameras.

One aspect of the present disclosure makes it possible to reduce a burden on an operator while eliminating blind spots of a plurality of cameras by performing photographing using the cameras.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082622, filed May 16, 2025, which is hereby incorporated by reference herein in its entirety.

What is claimed is:

1. An information processing system comprising:
a memory storing instructions, and
at least one processor configured to execute the instructions to:
acquire a plurality of images photographed by a plurality of cameras installed such that at least part of a medical imaging apparatus is included in a photographing range;
detect a plurality of targets from the plurality of images; and
select a first image from the plurality of images based on results of the detection o the plurality of targets.

2. The information processing system according to claim 1, wherein the at least one processor is configured to select one or both of (i) an abnormality-determining image of a subject related to the medical imaging apparatus and (ii) a display image displayed on a display of the medical imaging apparatus as the first image.

3. The information processing system according to claim 1, wherein the at least one processor is configured to
detect a placement region that is a region included in the medical imaging apparatus to place a subject thereon as one of the plurality of targets, and
select the first image from the plurality of images based on detection of the placement region from an image.

4. The information processing system according to claim 1, wherein the at least one processor is configured to
detect a placement region that is a region included in the medical imaging apparatus to place a subject thereon as one of the plurality of targets, and
select the first image from the plurality of images based on a size of the placement region detected from an image.

5. The information processing system according to claim 1, wherein the at least one processor is configured to
detect a placement region that is a region included in the medical imaging apparatus to place a subject thereon as one of the plurality of targets, and
select the first image from the plurality of images based on a degree of inclination in an image of the placement region detected from the image.

6. The information processing system according to claim 1, wherein the at least one processor is configured to
detect a placement region that is a region included in the medical imaging apparatus to place a subject thereon as one of the plurality of targets, and
select the first image from the plurality of images based on clarity of the placement region detected from an image.

7. The information processing system according to claim 1, wherein the at least one processor is configured to
detect (i) a placement region that is a region included in the medical imaging apparatus to place a subject thereon as a first target which is included in the plurality of targets, and (ii) a person as a second target included in the plurality of targets, and
select the first image from the plurality of images based on result of detection of the placement region and result of detection of a subject or a specific part of the subject.

8. The information processing system according to claim 2, wherein the at least one processor is configured to execute abnormality-determining processing of determining an abnormality of the subject placed on the medical imaging apparatus by using the abnormality-determining image.

9. The information processing system according to claim 8, wherein it is determined by the abnormality-determining processing that there is an abnormality in a case where it is determined that a predetermined part of the subject is outside a placement region, based on the placement region that is a region included in the medical imaging apparatus to place the subject thereon, and the predetermined part of the subject, the placement region and the predetermined part being detected from the abnormality-determining image.

10. The information processing system according to claim 8, wherein an abnormality in a physical condition of the subject is determined by the abnormality-determining processing based on color information of a face portion of the subject detected from the abnormality-determining image.

11. The information processing system according to claim 8, wherein an abnormality in an anesthetic state of the subject is determined by the abnormality-determining processing based on motion information of the subject detected from the abnormality-determining image.

12. The information processing system according to claim 8, wherein the at least one processor is configured to execute display control processing of controlling output to the display based on the first image and a determination result of the abnormality-determining processing.

13. The information processing system according to claim 12, wherein the display image is displayed on the display by the display control processing.

14. The information processing system according to claim 12, wherein the at least one processor is configured to execute the display control processing to display, in a case where the display image is an image including in a photographing range a region that is at a blind spot of an operator of the medical imaging apparatus, the display image on the display, and not to display, in a case where the display image is an image not including in the photographing range the region that is at the blind spot of the operator, the display image on the display.

15. The information processing system according to claim 12, wherein the at least one processor is configured to execute the display control processing to display, in a case where a determination result of the abnormality-determining processing indicates presence of the abnormality, the abnormality-determining image on the display.

16. The information processing system according to claim 12, wherein the at least one processor is configured to execute the display control processing to display, in a case where a determining result of the abnormality-determining processing indicates presence of the abnormality, notification information for notifying an operator of the medical imaging apparatus of contents of the abnormality on the display.

17. The information processing system according to claim 12, wherein the at least one processor is configured to execute the display control processing to display, in a case where a determining result of the abnormality-determining processing indicates presence of the abnormality, an image in which an abnormality part in the first image has been emphasized on the display.

18. An information processing method executed by a processor, the information processing method comprising:
acquiring a plurality of images photographed by a plurality of cameras installed such that at least part of a medical imaging apparatus is included in a photographing range;
detecting a plurality of targets from the plurality of images; and
selecting a first image from the plurality of images based on results of the detection of the plurality of targets.

19. A non-transitory computer readable medium that stores a program, wherein the program causes a computer to execute an information processing method comprising:
acquiring a plurality of images photographed by a plurality of cameras installed such that at least part of a medical imaging apparatus is included in a photographing range;
detecting a plurality of targets from the plurality of images; and
selecting a first image from the plurality of images based on results of the detection of the plurality of targets.
